(19) United States
(12) Patent Application Publication
(10) Pub. No.: US 2008/0250928 A1
(43) Pub. Date: Oct. 16, 2008

(54) Differential ion generator

(76) Inventors: Donald DeSalvo, Mercer Island, WA (US); Ho-Keung Mann, Kowloon (HK)

Correspondence Address: BLACK LOWE & GRAHAM, PLLC, 701 FIFTH AVENUE, SUITE 4800, SEATTLE, WA, 98104, US

(21) Appl. No.: 11/999,741

(22) Filed: Dec. 5, 2007

Related U.S. Application Data
(60) Provisional application No. 60/875,664, filed on Dec. 19, 2006.

(51) Int. Cl. B03C 3/38; B03C 3/68

(52) U.S. Cl. 96/16; 96/54; 96/25; 96/26

(57) ABSTRACT

A dual ion generating module is incorporated into a conventional household appliance. The module alternately generates both positive (Antions) and negative (Anions) ions when the appliance is powered.

### CROSS REFERENCE TO RELATED APPLICATIONS

This application claims the benefit of the filing date of copending U.S. Provisional Application Ser. No. 60/875,664 titled “Differential Ion Generator,” filed Dec. 19, 2006 under 35 U.S.C. §119(e).

### TECHNICAL FIELD

The invention relates to ionic air purifiers. More specifically, the invention relates to ion air purifiers employing plasma cluster technology.

### BACKGROUND OF THE INVENTION

The first to introduce the “Plasmacluster” technology and apply this theory to an air purifier was Sharp Corporation in Japan. The information and principal of how this “Plasmacluster ion” works to clean the air, kill the bacteria and virus can be found on the Internet.

The table below is data of negative ion contents of fresh air in nature:

| Natural Area | Negative Ion Content |
|---|---|
| Forest and waterfall area | 100,000 to 500,000 n-ion/cm cube |
| High mountain, seashore | 50,000 to 100,000 n-ion/cm cube |

### SUMMARY OF THE INVENTION

From the above data, the dual features of the Differential Ion Generator (hereinafter “DIG”) can be appreciated. Apart from performing the air purification, the DIG can generate sufficient negative ions (500,000 n-ions) to clean the surrounding air as fresh as in the forest or seashore.

In a preferred embodiment of the invention, a control timing circuit is added to the DIG to control a 3 second output interval of Anion and Cation terminals. This will increase the flowing of the ions in the area.

### BRIEF DESCRIPTION OF THE DRAWINGS

FIG. 1 is a perspective view of a table lamp incorporation the invention.

FIG. 2 is a block diagram representation of a preferred embodiment of the invention.

FIG. 3 is a circuit diagram of the invention.

### DETAILED DESCRIPTION OF THE PREFERRED EMBODIMENTS

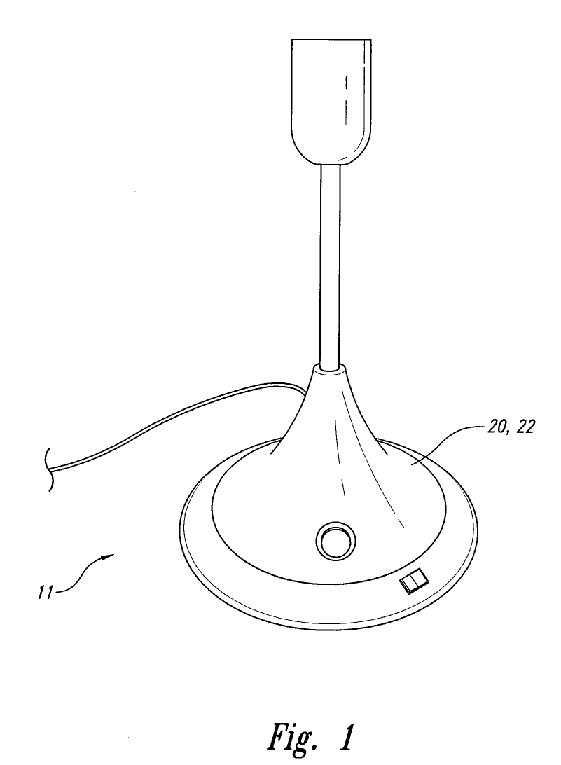

A preferred embodiment of the invention is shown in FIGS. 1, 2 and 3 and is in the form of a module 10 which can be incorporated into a variety of powered household devices, such as a lamp base 11. The invention has the following features:

Assists in the production of active oxygen

Assists in the absorption of oxygen of up to 20%

Improves sleeping conditions

Purifies air, assists in removing bacteria and viruses

Assists in relieving odors and smoke

May be recommended for nervousness, asthma, pollen allergy and chronic bronchitis

The invention has the following specifications:

DIFFERENTIAL ION GENERATOR MODULE SPECIFICATION

| | |
|---|---|
| Measurement: | 2.75″ × 1.6″ × 0.6″ (70 mm × 40 mm × 16 mm) |
| Input Power: | Optional 110 Volt AC |
| | 220 Volt AC or |
| | 12 Volt DC |
| Power Consumption: | Optional 0.3 W, or 0.4 W |
| Ion Generation: | Negative 4 KV Anion 3 × 1,000,000/cm³ and |
| | Positive 3 KV Cation 2 × 1,000,000/cm³ |
| | Negative 6 KV Anion 4 × 1,000,000/cm³ and |
| | Positive KV Cation 3 × 1,000,000/cm³ |
| Ion Output Interval | 3 sec. Anion output and 3 sec. Cation output |
| Control: | alternatively |
| Operating | Minus 5 C. to 50 C. |
| Temperature: | |

The invention may be employed in the following types of products: bedside lamps, desk lamps, hotel lamps, hospital lights, etc. Those of ordinary skill in the relevant art will conceive of other household appliances into which the module 10 may be incorporated.

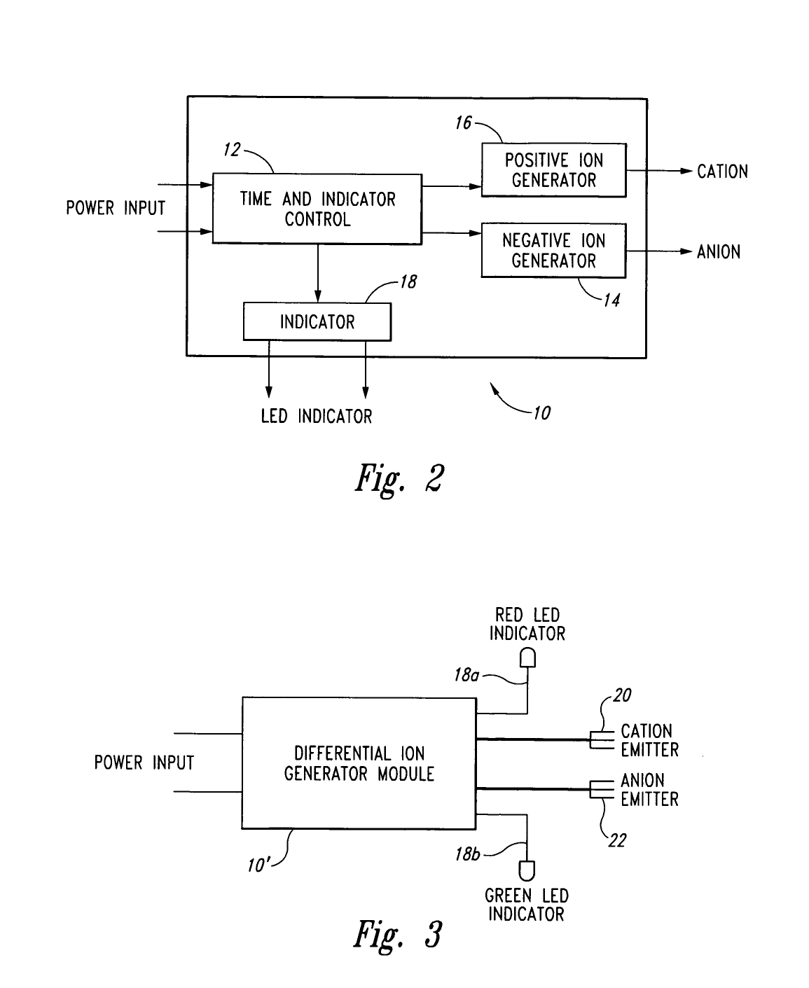

As best seen in FIG. 2, one embodiment of the module 10 includes a time and indicator control circuit which alternatively pulses a conventional negative ion (Anion) generator 14 and a conventional positive ion (Cation) generator 16 at 3 second intervals (i.e., 3 second duty cycle). The time and indicator control circuit also powers an operational indicator 18 such as a conventional light emitting diode (LED).

In an alternate embodiment 10 shown in FIG. 3, each emitter 20, 22 is associated with its own indicator 18a, 18b. Either embodiment is powered whenever the household appliance is turned on.

We claim:

1. An ionic air purifier, comprising:
a household appliance;
an ionic module having both positive and negative ion generators; and,
control means for alternately powering the generators.

2. The purifier of claim 1, wherein the generators are alternately pulsed by the control means for three seconds each.

3. The purifier of claim 1, wherein the household application is selected from one of a bedside lamp, a desk lamp, a hotel lamp and a hospital light.

4. The purifier of claim 1, wherein each generator has associated therewith a distinct visual indicator to indicate operation of each generator.
